(19) United States
(12) Patent Application Publication
(10) Pub. No.: US 2009/0277470 A1
(43) Pub. Date: Nov. 12, 2009

(54) Artificial nail decorating system utilizing computer technology

(76) Inventors: Monique M. Mitchell, Kissimmee, FL (US); Russell L. Mitchell, Kissimmee, FL (US)

Correspondence Address: THE INVENTORS NETWORK, INC., 332 ACADEMY STREET, CARNEGIE, PA, 15106, US

(21) Appl. No.: 12/151,443

(22) Filed: May 8, 2008

(51) Int. Cl. A45D 29/00; G09G 5/00; G06F 3/033; G06F 3/037

(52) U.S. Cl. 132/285; 132/73; 345/582; 345/179; 345/180

(57) ABSTRACT

A portable digital and electronic nail color and design kit for quickly and easily applying various images to artificial nails that are affixed to natural human nails, and then changing the appearance of the artificial nails, includes a compact case with color, design, and picture images stored in a computer graphics program and at least three windows for selecting and displaying the various images and a light pen connected to the compact case for transferring the selected color, design, and picture image to the artificial nails by touching the light pen tip to a designated area on the upper surface of the artificial nail thereby transferring the data for that image temporarily stored in the light pen tip to the artificial nail for representation on an exceptionally high pixel count mini-monitor on the artificial nail with the compact case being battery or solar powered, and capable of accessing and downloading images stored on a computer or from web sites via the Internet, and the compact case also including calculator, date/time, and memo pad functions.

### FIELD OF THE INVENTION

The present invention pertains to nail color and decorating kits, and more particularly pertains to an artificial nail decorating kit that utilizes computer technology to easily change the color and design of nails within a short time frame.

### BACKGROUND OF THE INVENTION

Decorating and painting one's nails is a worldwide cultural phenomenon that probably predates pre-dynastic Egypt, and which has personal, cultural, social, and even religious connotations and meanings. The materials that comprise the nail coloring or paint have advanced from natural substances mixed and processed in the home, the village market, the shop or temple to items and products mass produced on computerized assembly lines. However, the application of nail paint to one's fingernails is still a time-consuming and labor-intensive process whether it occurs at home or the salon. But as the colors and designs for nails have expanded far beyond the basic hues, so has the desire to experiment and change one's nail coloring on a regular basis. Yet this is not easy to accomplish when using synthetic nail paints and colorings that require time for application, time for drying and setting, and time for removal so that a new application can be made. Thus, it is desirable to have a system or process that allows one to change one's nail coloring easily and quickly and without the mess that accompanies the use of synthetic and packaged nail paints and colorings.

For example, the Beining et al. patent (U.S. Pat. No. 4,692,809) discloses an integrated touch paint system for displays that includes a faceplate and an active touch panel area disposed between the faceplate and a bezel for completing an electrical path to create a display.

The Goldstein patent (U.S. Pat. No. 5,007,441) discloses an electric nail polish remover that includes an upper housing rotatably mounted to a lower housing by a coaxial drive shaft with the upper housing containing a reservoir for nail polish remover fluid and an endless belt extending through the fluid and fingernail ledge positions for accommodating the fingernails and bringing them in registration with the belt for fingernail polish removal.

The Veasy et al. patent (U.S. Pat. No. 5,343,220) discloses an electronic paintbrush apparatus that simulates an electronic paintbrush carrying paint with the paint characteristics determined in part by the force of an indicator that moves above and over the surface.

The Mead et al. patent (U.S. Pat. No. 5,488,204) discloses a paintbrush stylus for capacitive touch sensor pad includes a touch sensor pad and a conductive paintbrush-type stylus is used to produce point-like strokes on a display.

The Challener patent (U.S. Pat. No. 5,959,616) discloses a computer input stylus and color control system wherein the stylus includes a color display that illuminates a conical tip of the stylus with a currently selected color.

The Forsline et al. patent (U.S. Pat. No. 6,801,211 B2) discloses a computer painting system with passive paintbrush stylus that includes a touch screen apparatus, at least one display and a stylus for applying pressure to the touch screen apparatus for producing images on the display with the touch screen apparatus and the display being incorporated into one device.

The Lin et al. patent (U.S. patent publication no. 2002/0050983 A1) discloses a touch sensing apparatus for receiving input from one or more touch stimulating devices.

The Hylen patent (U.S. patent publication no. 2002/0118209 A1) discloses a computer program product for applying painting effects to a digitized image.

Nonetheless, despite the ingenuity of the above devices, there remains a need for a portable nail decorating kit that utilizes computer technology that allows a woman to decorate her artificial nails quickly, and then change the design and/or color images as often as desired.

### SUMMARY OF THE INVENTION

The present invention comprehends a portable digital and electronic nail color and design system that utilizes computer technology to quickly and easily decorate, design, and color artificial nails that are affixed to one's nails, and then change the color and/or design application quickly and with little effort or mess. The system comes in the form of a portable kit that provides for the electronic transference of a range of designs, colors, and pictures electronically stored as computerized images in a computer graphics program of a compact case onto the artificial nails via a light pen.

Thus, the nail color and design system includes a lightweight, portable, electronic compact case that has a USB adapter cable that plugs into a port that connects to the hard drive of a computer for downloading designs, colors, and pictures from a ready-made computer data base or via web sites from the Internet to memory storage that is integrated with the micro circuitry and graphics program contained within the compact case. The compact case includes the graphics image program wherein the color, design, and picture images are stored and accessed, and three screens that are designated the main menu window, the color/design selection window, and the desired result display window which display the selected nail color, design, or picture application image.

The compact case includes a light pen socket into which a plug at the end of a light pen cable is inserted. The light pen includes a transfer tip that is used to transfer by conventional electrical or electromagnetic means the specific image (color, design, or picture) onto the artificial fingernail. The compact case can be designed to operate and run by either solar power or battery power.

The system or kit also includes a plurality of artificial nails (at least ten with several spares) with each artificial nail including an upper surface and an opposite lower surface. Adhesive is applied to the lower surface for affixing the artificial nail to the individual's nail. Contained within the body of each artificial nail is a built-in memory chip/processor that stores for a pre-determined time period—preferably between 8-12 hours—the data corresponding to the selected nail color, design, or picture image. Each artificial nail also has its own miniaturized power source—either kinetic or solar—and the upper surface includes a display surface in the form of a miniature monitor that displays the image representing the selected color, design or picture. The mini-monitor has an exceptionally high pixel count for producing bright and clear images. Each artificial nail also includes a circular contact area on its upper surface that is the designated area for contact by the tip of the light pen. Upon contact from the light pen tip the information (data) for that image that has been temporarily stored by the light pen is transferred (by any conventional electrical and/or electromagnetic inductance) to the artificial nail. The built-in memory chip holds the application image for the predetermined time period, and the exceptionally high pixel count mini-monitor displays the image as a virtually real color, design, or picture.

The system or kit also has the capability to access and download various color, design, and picture images available on select web sites via the Internet by connecting the compact case to a computer through a USB adapter cable. Thus, a range of graphical images can be accessed, downloaded, and stored in memory storage of the compact case from web sites on the Internet via a home computer or laptop computer. It is also possible to program the built-in memory chip/processor of the artificial nails for giving the color, picture, and design images displayed on the nail's mini-monitor motion capabilities.

It is an objective of the present invention to provide a digital and electronic nail color and design system that allows for on-the-fly nail design, color and change as desired.

It is another objective of the present invention to provide a digital and electronic nail color and design system that allows for a faster application of the desired design and/or color to the artificial nails.

It is still another objective of the present invention to provide a digital and electronic nail color and design system that allows for a broader range of color and design selections available through downloads from databases, computer downloads and downloads from web sites via the Internet.

It is yet another objective of the present invention to provide a digital and electronic nail color and design system that is more cost effective in the long run by reducing the amount of visits to manicurists and pedicurists.

It is still yet another objective of the present invention to provide a digital and electronic nail color and design system that is more user friendly in that it eliminates the mess of traditional nail color applications and allows the images on the artificial nails to be changed in seconds not minutes as with traditional nail color applications.

It is still yet a further objective of the present invention to provide a digital and electronic nail color and design system wherein the compact case also includes such programmable capabilities as a calculator, a date/time keeper, and a memo pad.

Still another objective of the present invention is to provide a digital and electronic nail color and design system that gives a professional quality nail application that can be used by children and adults.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the digital and electronic nail color and design, system of the present invention illustrating the primary components of the system including the compact case, the light pen and the computer with a monitor;

FIG. 2 is a perspective view of the digital and electronic nail color and design system of the present invention illustrating the insertion of the USB plug into the USB port on the compact case;

FIG. 3 is a perspective view of the digital and electronic nail color and design system of the present invention illustrating the connection of the light pen to the light pen socket of the compact case;

FIG. 4 is a perspective view of the digital and electronic nail color and design system of the present invention illustrating the tip of the light pen being brought into contact with area of the artificial nail that provides for the transfer of the particular image from the light pen to the nails;

FIG. 5 is a side elevational view of the digital and electronic nail color and design system of the present invention illustrating the application of one artificial nail to the nail of the individual;

FIG. 6 is a schematic flowchart of the digital and electronic nail color and design system of the present invention illustrating the power supply and processing components for one artificial nail;

FIG. 7 is a schematic flowchart of the digital and electronic nail color and design system of the present invention illustrating the components that comprise the artificial display nail;

FIG. 8 is a front elevational view of the digital and electronic nail color and design system of the present invention illustrating one representative example for the main menu, the color/design selection, and the display results windows when a particular color is chosen for applying to the artificial nail;

FIG. 9 is a front elevational view of the digital and electronic nail color and design system of the present invention illustrating one representative example for the main menu, the color/design selection, and the display results windows when a particular design is chosen for applying to the artificial nail;

FIG. 10 is a front elevational view of the digital and electronic nail color and design system of the present invention illustrating one representative example for the main menu, the color/design selection, and the display results windows when a particular picture is chosen for applying to the artificial nail;

FIG. 11 is a front elevational view of the digital and electronic nail color and design system of the present invention illustrating indicia that appear on the various screens on the compact case when the download function is selected;

FIG. 12 is a front elevational view of the digital and electronic nail color and design system of the present invention illustrating indicia that appear on the various screens of the compact case when the calculator function is selected;

FIG. 13 is a front elevational view of the digital and electronic nail color and design system of the present invention illustrating indicia that appear on the various screens of the compact case when the date and time function is selected;

FIG. 14 is a front elevational view of the digital and electronic nail color and design system of the present invention illustrating indicia that appear on the various screens when the memo pad function is selected;

FIG. 15 is a schematic view of the digital and electronic nail color and design system of the present invention illustrating the primary circuitry components of the electronic compact case;

FIG. 16 is a representative flowchart for the digital and electronic nail color and design system of the present invention illustrating the steps undertaken in selecting and the applying a particular color, design, or picture image to one or more artificial nails that are affixed to the individual's natural nail;

FIG. 17 is a representative flowchart for the digital and electronic nail color and design system of the present invention illustrating the steps undertaken for downloading graphical images stored in a PC computer file or database to the electronic compact case; and

FIG. 18 is a representative flowchart for the digital and electronic nail color and design system of the present invention illustrating the steps undertaken for downloading graphical images from a web site on the Internet to the electronic compact case.

### DETAILED DESCRIPTION OF THE PREFERRED EMBODIMENT

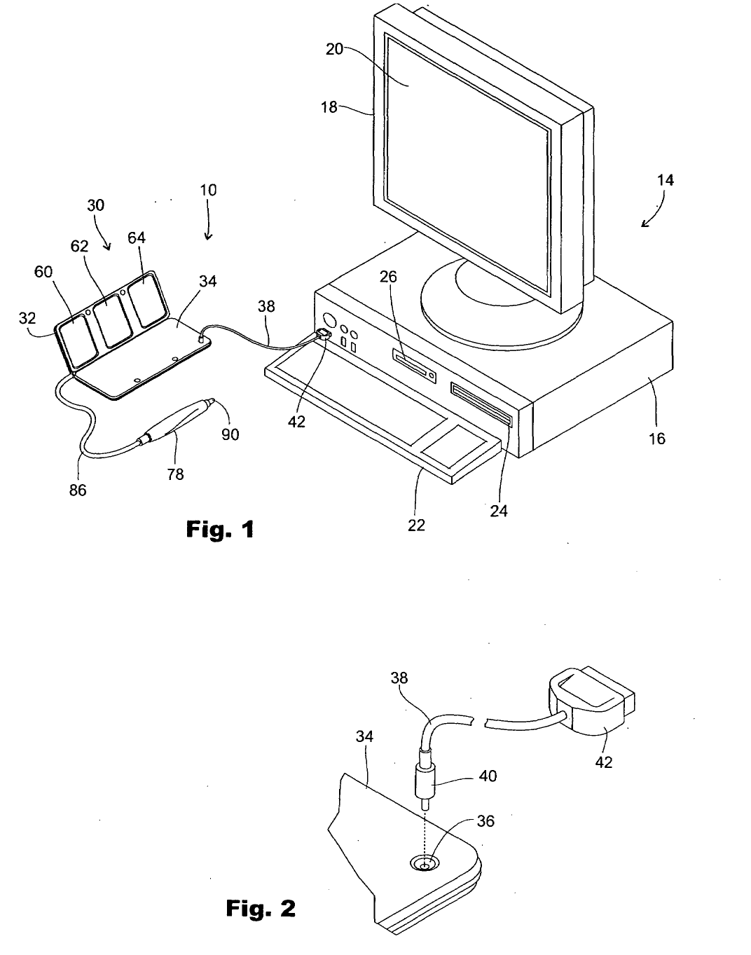

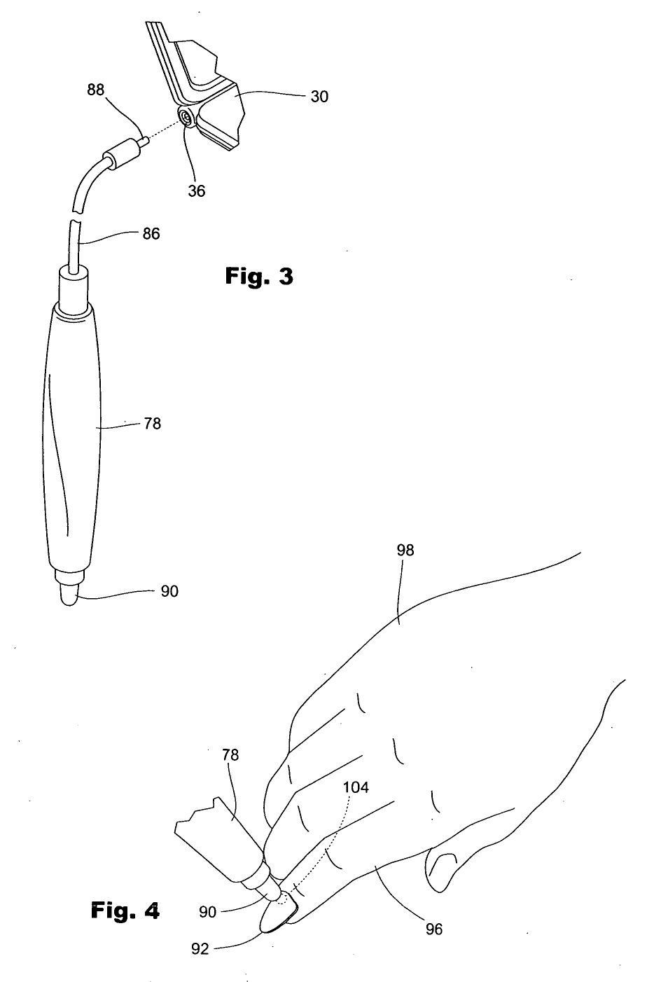

Illustrated in FIGS. 1-18 is a portable digital and electronic nail color and design system 10 or simply referred to as an artificial nail decorating kit that allows an individual to quickly and easily select and apply a -graphical image, ranging across a wide variety of colors, designs, and pictures, to artificial nails 12. The selected image is held on the artificial nail 12 by electromagnetic means for a time period, and then another image can be applied to the artificial nail by using the kit quickly and without any mess.

The nail color and design system 10 can be used in conjunction with a PC computer 14 that includes a hard drive case or tower 16, a monitor 18 with a screen 20, a key board 22, slots 24 and 26 for CDs and DVDs, and various input and output ports and contacts including at least one USB port 28. The computer 14 can be used in conjunction with the nail color and design system 10 to access graphical images stored in files and databases of the computer 14 or to access graphical images from web sites over the Internet as will be hereinafter further described.

Thus, the nail decorating kit or color and design system 10 includes a portable, lightweight, durable electronic compact case 30 with one preferred dimension being three inches by three inches (length and width), and 0.125 inches thick by utilizing electronic micro circuitry and components. The compact case 30 includes a window member 32 that is hingably attached to a body member 34 with the circuitry and components housed within the body member 34. Located on the face of the body member 34 is a USB port 36 into which a USB adapter cable 38 can be plugged, specifically the plug end 40 of the USB cable 38. The contact head 42 of the USB cable 38 is plugged into the appropriate port 26 and 28 on the computer 14 to provide for data accessing, transference, and downloading. The compact case 30 also includes a light pen socket 44 opposite of the USB port 36.

As shown in FIG. 15, the primary circuitry components of the electronic compact case 30 includes a processor 46, a graphics program 48, a memory storage 50, and a bus 52 for routing and directing commands, requests, inputs, and outputs among the aforedescribed components. In addition, a capacitor 54 is electrically interconnected between the processor 46 and either a solar power component 56 or a battery supply 58 either of which can provide power to the compact case 30. The aforedescribed components 56 or 58 are electrically interconnected in any known and conventional manner.

As shown in FIGS. 1 and 8-14, the window member 32 further includes at least three separate screens that are electrically interconnected to the graphics program 48 and controlled by the processor 46. The screens are further designated the main menu window or screen #1 60, the color/design/picture selection window or screen #2 62, and the desired result display window or screen #3 64. Each window 60, 62, 64 displays specific indicia that are accessed, selected and pertain to the selection and application of various types or kinds of graphic images on the artificial nails 12. In addition to these primary screen functions, the compact case 30 also has such capabilities as a calculator function, a date/time function, and a memo pad function with indicia corresponding thereto and which appear on the various windows #1, #2, and #3 60, 62, and 64.

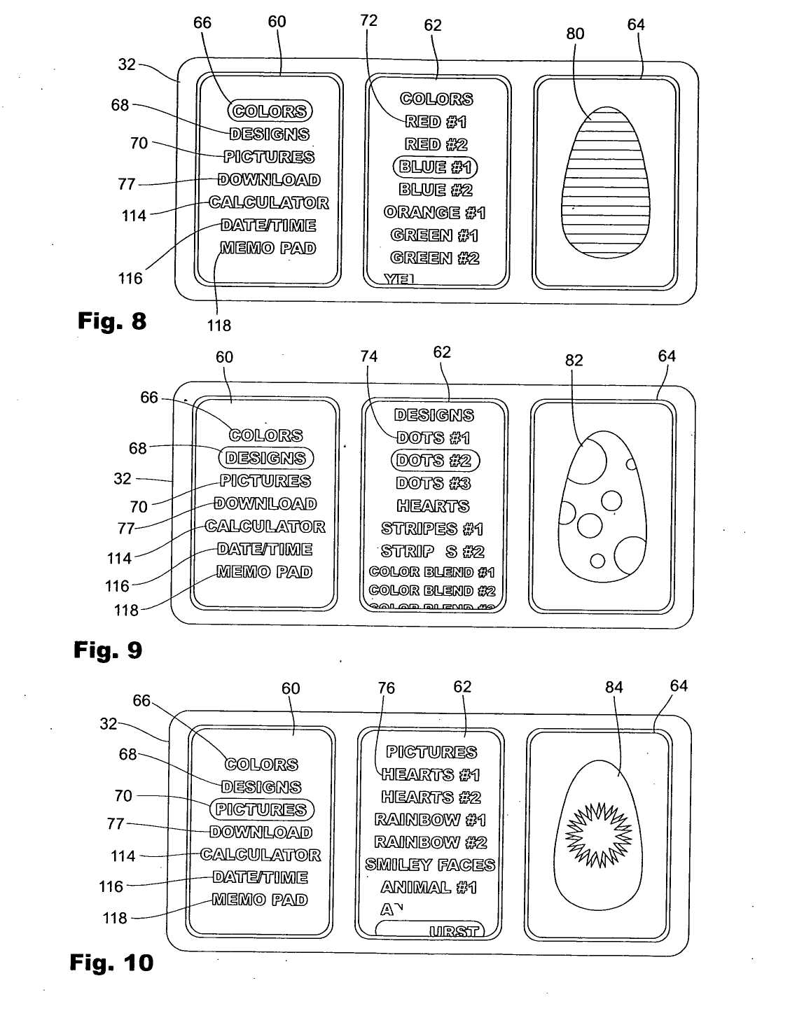

As shown in FIGS. 8-16, a range or variety of graphic images are stored in the graphics program 48 of the compact case 30 and which are accessed by the first level category of indicia denoted “colors,” 66 “designs,” 68 and “pictures.” 70. Each first level category leads to more specific second level specific categories with the colors category or group 72 including numerous colors, the design category or group 74 including numerous designs, and the picture group or category 76 including numerous pictures. FIG. 8 illustrates the “colors” category 66 selected from the main menu of window #1 60, the numerous groups of colors 72 that can be selected from color/design/picture window #2 62, and the actual color image that appears in display window #3 64 as the full image to be applied to the artificial nails. FIG. 9 illustrates the selection of the “design” category or group 68 from the main menu that appears in window #1 60, the range of specific design images to select from the design group 74, and which appear in window #2 62, with the actual selected design image appearing in window #3 64 as the design for application to the artificial nails 12. FIG. 10 illustrates the main menu when the “picture” category 70 is selected from window #1 60, the range or group of pictures or picture images 76 that can be selected and which appear in window #2 62, and the actual selected picture image that appears in display window #3 64 as the picture image that will be applied to the artificial nails 12. Window #1 60 contains the main menu that is the initial window that is accessed to begin the process of decorating the artificial nails 12 by bringing the first level categories 66, 68, and 70 or selections up. A “download” function 77 is also included in window #1 for downloading images from the PC 14 or from a web site on the Internet.

As shown in FIGS. 1-7, a light pen 78 is used to touch, access, and move through and among the various windows 60-64 and for applying the desired color, design or picture images 80, 82 and 84 to the nails 12. The light pen 78 includes a light pen cable 86 terminating with a contact plug 88 that plugs into the light pen socket 44 of the compact case 30 so that the light pen 78 can be removed therefrom should the light pen 78 become damaged or defective. The light pen 78 includes a data tip 90 that is brought into physical contact with the windows 60-64, and more specifically, into contact with the indicia 66-76 that appear on the windows 60-64 for scrolling through, selecting and then transferring the selected color, design, or picture image such as images 80-84 (represented as electrical or electrically induced data) to the artificial nails 12 for displaying thereon. By representing the representative color, design or picture images 80-84 as electrical data transferable by electric-mechanical means from the compact case 30 to the nails 12 by the light pen 78, any mess that accompanies nail colors and designs embodied in a physical—liquid or paste—form is completely avoided.

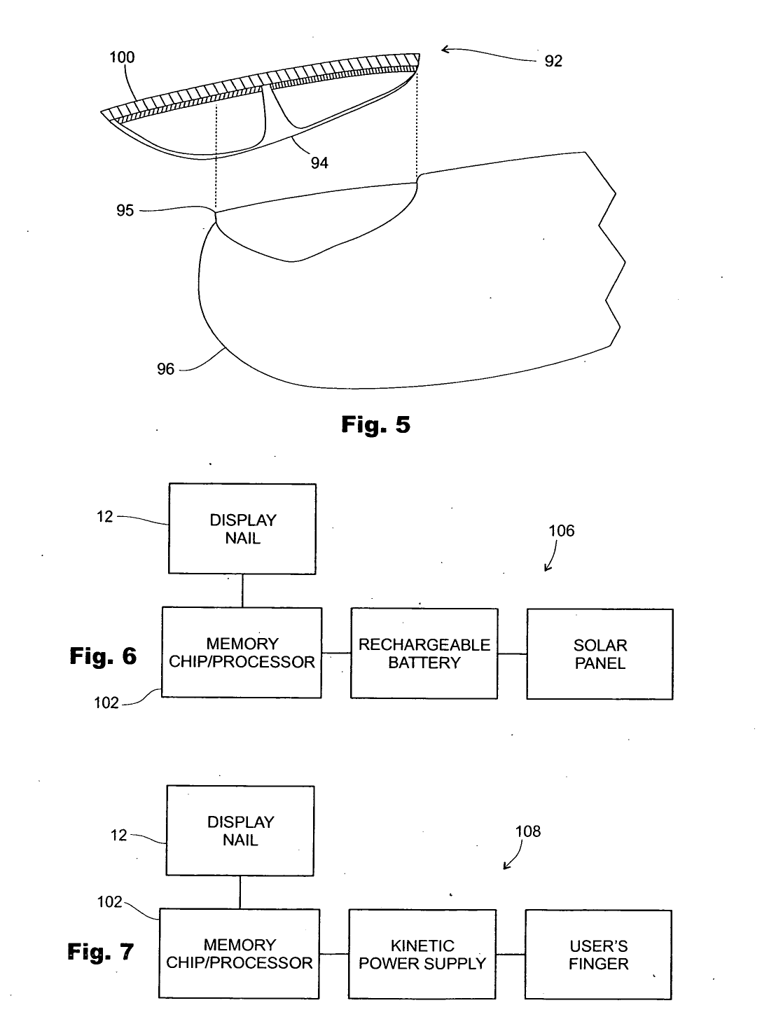

The artificial nails 12, as shown in FIGS. 4 and 5, include elements and features that allow for the application of the various color, design, and picture images 80-84 shown in windows #1, #2, and #3 60-64 of FIGS. 8-10 to the nails 12 and then their easy and quick change from one particular image to another image. Thus, each artificial nail 12 includes an upper surface 92 and an opposite lower surface 94. The lower surface 94 is affixed to any natural nail 95 of any finger 96 on either hand 98 of the individual The upper surface 92 includes a miniature monitor 100 composed of or incorporating an exceptionally high pixel count or array for displaying the color, picture, or design images 80-84 in clear high-resolution detail. In addition, each nail 12 includes within the body of the nail 12 a built-in memory chip 102 that facilitates the holding of the image on the miniature monitor 100 as a virtually real image. A specific area on the upper surface 92 of the nail 12 is designated as the light pen contact area 104 for contact by the tip 90 of the light pen 78 to facilitate transference of the image to the mini-monitor 100. The memory chip 102 is electrically connected to the miniature monitor 100 and the memory chip 102 is programmed to allow the miniature monitor 102 to hold and display the same image for preferably between 8 and 12 hours; although the image on the nail 12 can be changed at any time if so desired. Further, each artificial nail 12 includes its own miniaturized power source as shown in the FIGS. 6 and 7 schematic power source flowcharts 106 and 108, for providing the power to hold the representative virtually real color, design, or picture image 80-84. The miniaturized power source is electrically interconnected to the miniature-monitor 100 and the built-in memory chip 102.

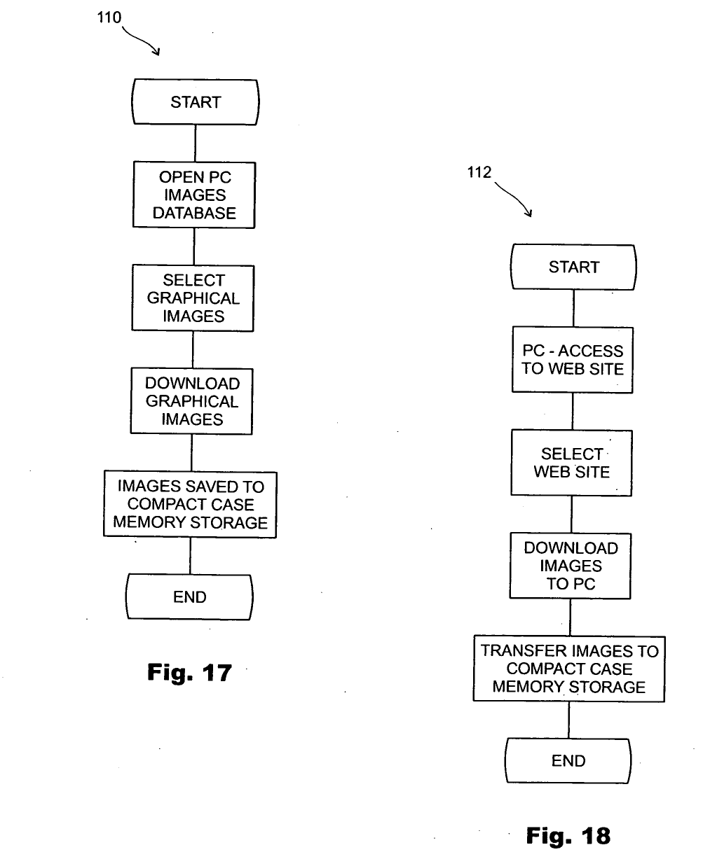

As shown in FIGS. 17 and 18, the nail decorating kit 10 also includes the capability of accessing and downloading graphical images of any sort from files and databases stored or ready made on the PC 14 or from various web sites found on the Internet for transference and saving such images into memory storage 50 of the compact case 30. This gives the individual a much wider range of artistic and graphical images to select from for decorating one's nails 12. Thus, in the download images from the PC schematic 110 of FIG. 17 the individual would first open the particular file or database containing the graphic images, then the individual would select the image or images he or she wants to transfer and download and then the step for downloading the selected graphical images would be initiated. Finally, the selected images are downloaded and saved to memory storage of the compact case 30.

The download graphic images from a web site schematic 112 of FIG. 18 illustrates the representative steps for accessing and downloading graphic images from an Internet web site. Thus, through the PC 14 the particular web site is located and then the graphic images on that web site are selected and downloaded to a file setup in the document partition of the PC 14. Finally, the graphic images are transferred from the computer file to the memory storage 50 of the electronic compact case 30.

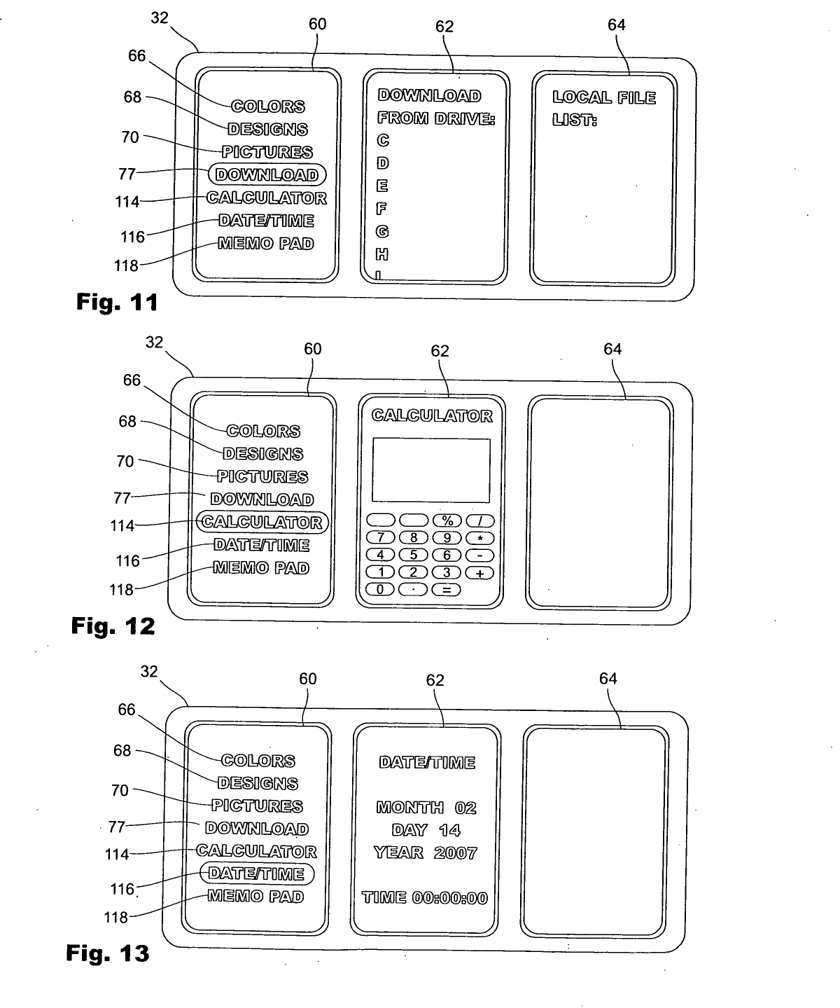

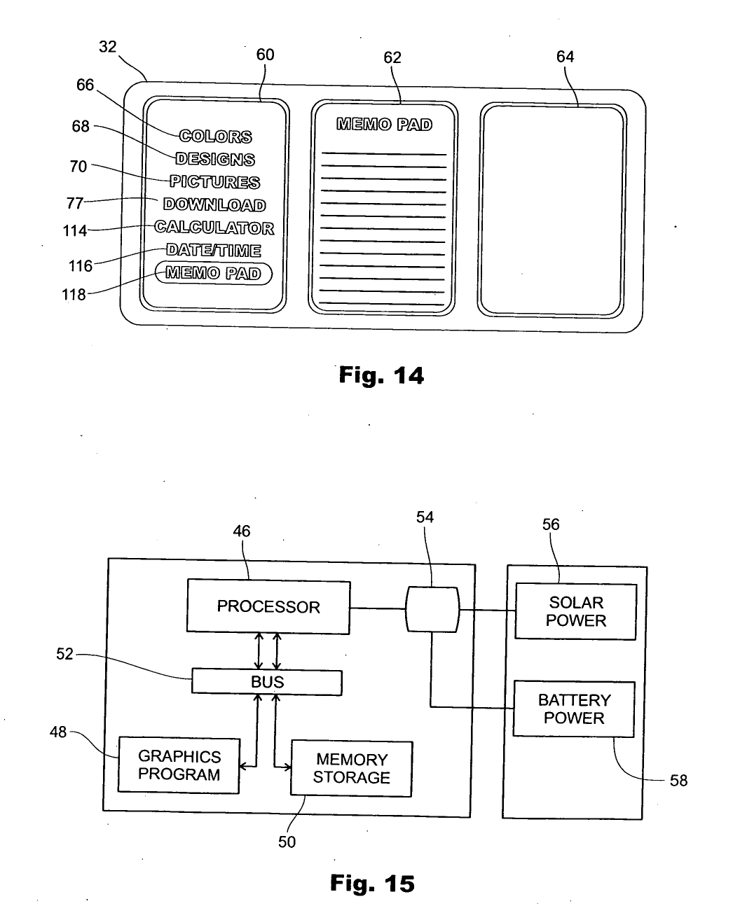

FIGS. 12-14 illustrate the various indicia and images that appear on windows #1, #2, and #3 60-64 when the calculator function 114, the date/time function 116 and the memo pad function 118 are initially selected from main menu window #1 60. Thus, as shown in FIG. 12, when the calculator function 114 is selected by touching the tip 90 of the light pen 78 to the phrase “calculator,” the particular calculator function arrangement appears in window #2 62, and upon performing the desired calculations, the results would appear in window #3 64. As shown in FIG. 13, the date/time function 116 is selected by touching the tip 90 of the light pen 78 to the phrase “date/time,” on the main menu window #1 60 with date and time information and indicia appearing in window #2 62. FIG. 14 illustrates the selection of the memo pad function 118 by touching the tip 90 of the light pen 78 to the phrase “memo pad” on the main menu window #1 60, followed by the appearance of the memo pad configuration on window #2 62 with further additions, revisions, and alterations of language and notes for the memo pad appearing on display window #3 64.

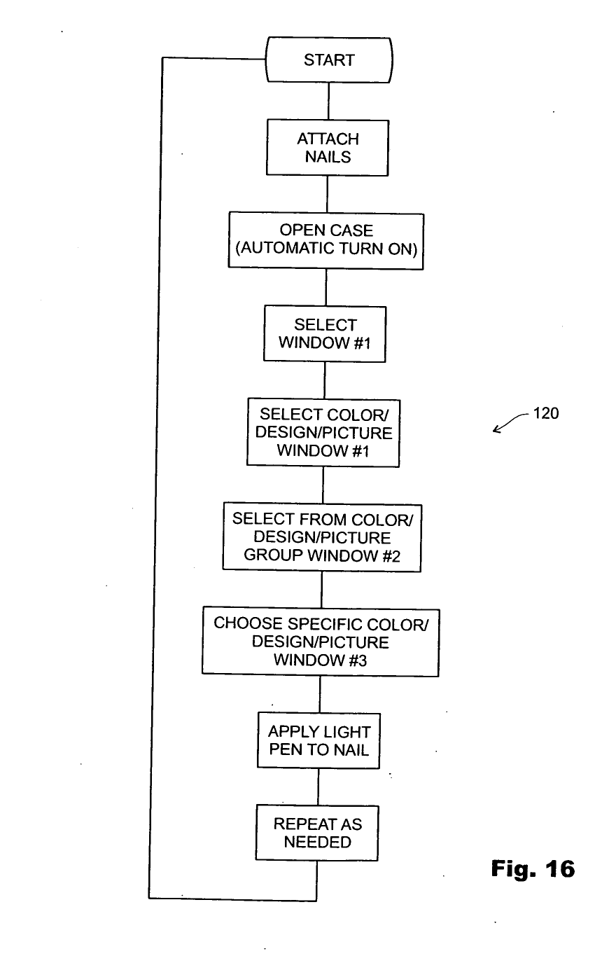

FIG. 16 illustrates a representative schematic or flowchart 120 that exemplifies the sequence of steps undertaken to apply any of the selected images 80-84 (color, picture, or design) to the nails 12. First, the artificial nail or nails 12 are affixed to the natural nail(s) 95 by using any appropriate adhesive to adhere the lower surface 94 of the artificial nail 12 to the natural nail 95. Then the compact case 30 is opened which automatically turns on the compact case 30. Main menu window #1 60 is then selected with the individual using the light pen 78 to touch the desired first level category indicia —colors 66, designs 68, pictures 70, calculator function 114, date/time function 116 or memo pad function 118. For decorating the artificial nails 12 one of the first level categories “colors” 66, “designs” 68, or the “pictures” 76 is selected. After selection of the desired first level category from the main menu indicia will appear on window # 2 62 as shown in FIGS. 8-10 for indicating the specific type of color image 80, category of design image 82, or type of picture image 84 selected from each respective group 72, 74, 76. The individual will then choose the specific type of color image form the colors group 72, the specific type of design image from the designs group 74, or the specific type of picture image from the pictures group 76 by touching the tip 90 of the light pen 78 to that particular image. Then the individual will touch the designated area 104 on the artificial nail 12 with the tip 90 of the light pen 78 thereby transferring the image 80, 82, 84 by electromagnetic induction means to the nail 12. The built-in memory chip 102 operating in conjunction with the miniature monitor 100 will then convert the data representing the particular color 80, design 82, or picture image 84 to a virtually real image for display on the monitor 100 with the memory chip 102 programmed to hold that image for between 8-12 hours unless the image is changed. This color and design decorating application can be repeated as often as needed as no physical liquid coloring or paint substances are used in the process.

Upon reference to the foregoing, those skilled in the art will appreciate that numerous modifications, alterations, and variations are possible and practicable while still remaining within the scope of the description and the ambit of the appended claims.

We claim:

1. An artificial nail decorating kit for decorating with graphic images an artificial nail that is applied to a fingernail of an individual, comprising:
an electronic compact case having a window member hingably attached to a base member;
the base member having a USB port and a light pen socket;
a main menu window #1, a color/design/picture window #2, and a display result window #3 mounted on the window member;
the main menu window #1 for displaying thereon a first level category of indicia that include colors, designs, and pictures;
the color/design/picture window #2 for displaying indicia in the form of a plurality of colors when the first level category of colors is selected, a plurality of designs when the first level category of designs is selected, and a plurality of pictures when the first level category of pictures is selected;
the display results window #3 for displaying a particular color, design, or picture image that is selected from the plurality of colors, designs, and pictures;
the compact case including a processor, a graphics-image program, and a memory storage that are-electrically interconnected to the main menu window #1, the color/design/picture window #2, and the display results window #3;
at least one artificial nail securable to the nail of the individual;
the artificial nail including a miniature monitor, a built-in memory chip and a power source;
a light pen having a light pen cable for connection to the light pen socket; and
the light pen having a data tip that is brought into contact with indicia displayed on windows #1, windows #2, and windows #3, and with the particular color image, design image, and picture image displayed on window #3 for transferring that respective image to the artificial nail where it is held by the memory chip for a predetermined time period and displayed as a virtually real image by the miniature monitor.

2. The artificial nail decorating kit of claim 1 wherein the compact case is in the off disposition when the window member is closed upon the base member and the compact case automatically turns on when the window member is opened up from the base member.

3. The artificial nail decorating kit of claim 2 wherein the power for the compact case is provided by a battery supply.

4. The artificial nail decorating kit of claim 3 wherein the power for the compact case is provided by a solar power component.

5. The artificial nail decorating kit of claim 4 wherein the power for the artificial nail is provided by a kinetic power supply.

6. The artificial nail decorating kit of claim 5 wherein the power for the artificial nail is provided by a solar supply.

7. The artificial nail decorating kit of claim 6 wherein the miniature monitor is composed of an exceptionally high pixel array.

8. The artificial nail decorating kit of claim 7 wherein the compact case includes a calculator function, a date/time function and a memo pad function that are displayed on and accessed through window #1.

9. The nail decorating kit of claim 8 wherein the compact case can download and store graphic images from web sites located on the Internet.

10. The nail decorating kit of claim 9 wherein the compact case can download and store graphic images from a database of file loaded on a PC.

11. The nail decorating kit of claim 10 further comprising a USB adapter cable for interconnecting the compact case to the PC so that the graphic images can be downloaded to the compact case from the PC and from web sites located on the Internet.
